(19) United States
(12) Patent Application Publication
(10) Pub. No.: US 2011/0253291 A1
(43) Pub. Date: Oct. 20, 2011

(54) DRYWALL FINISHING METHOD

(75) Inventors: Brian C. Allen, Raleigh, NC (US); Adrian Kent Allen, Wake Forest, NC (US)

(73) Assignee: LEVEL 7, LLC, Cary, NC (US)

(21) Appl. No.: 13/090,609

(22) Filed: Apr. 20, 2011

Related U.S. Application Data
(60) Provisional application No. 61/325,933, filed on Apr. 20, 2010.

(51) Int. Cl. B32B 37/14; B32B 38/00; B05D 3/00; C04B 28/00; B05D 1/02; B05D 1/28; B05D 5/06; B32B 37/02; B05D 1/38

(52) U.S. Cl. 156/91; 156/280; 156/154; 427/372.2; 427/355; 427/162; 106/638

(57) ABSTRACT

The invention provides a drywall finishing method. The method may include the steps of taping one or more drywall joints with drywall tape and allowing drying; applying a coat of joint compound composition covering substantially all of the drywall tape and allowing to dry; and applying a finishing coat of joint compound composition to substantially all of a drywall surface and allowing to dry. The invention further provides a joint compound composition suitable for use in the method of finishing drywall, wherein the joint compound composition comprises a composition compatible with conventional jointing compound material and exhibits improved properties of thickness, self leveling, elasticity, durability, photographing and/or mold resistance over that of conventional joint compound compositions.

### CROSS REFERENCE TO RELATED APPLICATIONS

This application is related to and claims priority to U.S. Provisional Patent Application Ser. No. 61/325,933 entitled Drywall Finishing System filed Apr. 20, 2010, the entire disclosure of which is specifically incorporated herein by reference.

### FIELD OF THE INVENTION

The present invention relates to drywall finishing. Specifically, the present invention relates to a drywall finishing method.

### BACKGROUND OF THE INVENTION

This invention relates to drywall finishing, and more particularly to a method for reducing the time and costs required to finish drywall.

The building industry widely uses drywall (also known as gypsum board or sheetrock), in the construction of residential homes, commercial buildings, and other structures. The drywall is usually pre-cut in flat sheets of 4×8 or 4×12 foot, having a thickness of ½ or ⅝″. Typically, sheets of drywall are hung on wood or metal studs using nails, screws, or other suitable fasteners to form an interior wall of a structure. Typically, the drywall is assembled together, and the joints, interior angles, and/or other imperfections, such as fastener heads, are finished with tape and/or joint compound (also referred to as mud), so as to obtain an overall visible outer surface which has a relatively uniform smooth surface for application of wallpaper, paint, or other decoration.

A conventional method of finishing the drywall before application of the final surface covering includes a number of labor intensive and time consuming steps, and the current state of the art typically designates five (5) different levels of drywall finishing from Level 1 to Level 5 that corresponds with the steps.

A conventional method of the prior art shown in FIG. 1, typically includes the following steps. First, a thin bead of drywall joint compound is deposited along the joints and interior angles and applied with a joint finishing knife to the joint (for example a six inch joint finishing knife). Immediately after that, a drywall tape is placed over the bead of the drywall joint compound and the joint finishing knife is run over the tape to press the tape and cause it to adhere to the compound. This first coat of the compound with the tape is allowed to dry for at least about 24 hours. This is typically considered a Level 1 finish, where all the joints and interior angles have tape set in the joint compound, and the surface is left free of excess joint compound. Typically, ridges and tool marks are acceptable at this level of finish. A Level 1 finish is typically found in areas that would generally be concealed from view or in areas that are not open to public traffic.

Once the first coat of compound with the tape has dried, then a second coat of joint compound is applied over the first coat to cover the tape completely and to cover the interface between the tape and the wall. This second coat is allowed to dry for at least about 24 hours and then sanded. This is typically considered a Level 2 finish, where all joints and interior angles have tape embedded in joint compound and wiped with a joint knife leaving a thin coating of joint compound over the tape and all joints and interior angles, and the surface is left free of excess joint compound. Ridges and tool marks are typically acceptable for a Level 2 finish. A Level 2 finish is typically found in garages, warehouse storage areas and other similar areas where the final surface appearance is not of high importance.

Once the second coat of compound covering the tape has dried, then a third coat (e.g., a skim coat) is applied with a joint finishing knife (e.g., a 10-inch joint finishing knife), to make a wide strip of the joint compound on the wall that would entirely cover the tape as well as the first two coats. This third coat is allowed to dry for at least about 24 hours and then sanded. This is typically considered a Level 3 finish, where all joints and interior angles have tape embedded in joint compound and an additional coat of joint compound applied over all joints and interior angles. Also, fastener heads (screws, nails, etc.), and accessories are typically covered with separate coats of joint compound. All joint compound at this level is smooth and free from tool marks and ridges. A Level 3 finish is typically found in areas to be decorated with a medium or heavy texture or where heavy-grade wall coverings will become the final decoration.

After the third coat of joint compound has dried, then a fourth coat (finish skim coat) is applied with a joint finishing knife, to make a wider strip of the joint compound on the wall that is wide enough to entirely cover the tape as well as the first three coats. The finish skim coat typically uses a thinner joint compound composition. When the fourth coat dries, again for at least about 24 hours, it is sanded to remove imperfections and achieve a smooth finish. The dust is wiped off or blown off to make the wall ready for primer paint, wallpaper, paint, other decoration application, or a Level 5 finish. This is typically considered a Level 4 finish, where all joints and interior angles have tape embedded in joint compound and two separate coats of joint compound and two separate skim coats applied over all joints and interior angles. Also, fastener heads and accessories are covered with separate coats of joint compound, and all joint compound at this level is smooth and free from tool marks and ridges. A Level 4 finish is typically found in areas where the final decoration is to be a flat paint, light texture or lightweight wall covering.

If a Level 5 finish is desired, after the fourth coat has dried, a thin skim coat of joint compound, or other material manufactured especially for this purpose (e.g., a Level 5 finishing compound, such as LEVELCOAT™ by Magnum Products, Lenexa, Kans.; SHEETROCK® Brand TUFF-HIDE™ by USG Corporation, Chicago, Ill.; or SPRAY-PLAST® by Tool World, Inc. Eustis, Fla.), is applied to the entire assembled drywall surface, either by hand (e.g., roller application), or spray application. After the skim coat has dried, sanding is performed yet again to produce a flat surface. Prior to the application of finish paint, the prepared surface is coated with drywall primer paint. At a Level 5 finish the surface is smooth and free from tool marks and ridges. A Level 5 finish provides a uniform surface and minimizing the possibility of joint photographing and/or fasteners “burning through” the final decoration. A Level 5 finish is typically found in areas where severe lighting conditions exist and areas that are to receive gloss, semi-gloss, enamel or non-textured flat paints.

The disadvantage of the conventional method is that the entire process is highly labor and time intensive. The conventional method requires several days (4-5) to finish a wall, with a 24-hour drying period between joint compound applications. The drywall finisher has to come back to the same job several times before the walls are finished. The time spent on finishing the walls directly translates into the cost of the building construction. It would be therefore a considerable advantage to provide a method that would reduce the labor time in finishing the drywall and thereby reduce the overall cost of construction. Therefore, a need exists in the art for drywall finishing that result in improved efficiency to decrease the amount of time as well as reduce the cost and labor of finishing drywall.

### SUMMARY OF THE INVENTION

In one embodiment, the invention provides a method of finishing drywall. The method may include taping one or more drywall joints with drywall tape and allowing drying; applying a coat of joint compound composition covering substantially all of the drywall tape and allowing to dry; and applying a finishing coat of joint compound composition to substantially all of a drywall surface and allowing to dry.

Taping the one or more drywall joints with drywall tape may further include applying the joint compound composition along the one or more drywall joints; applying drywall tape over the joint compound composition; applying pressure to the tape to cause it to adhere to the joint compound composition; and allowing the joint compound composition with the drywall tape to dry.

The method may further include applying joint compound composition over fastener heads prior to applying the finishing coat.

The method may further include taping and/or applying the joint compound composition to interior angles prior to applying the finishing coat.

The method may further include applying the finishing coat to the drywall surface by spray application or by roller application.

The method may further include applying the coat of joint compound composition covering substantially all of the drywall tape by spray application.

The method may further include applying the joint compound composition covering the fastener heads and/or interior angles by spray application.

The method may further include sanding all or a portion of the coated drywall surface after each coating of the joint compound composition has dried.

The method may further include the finishing coat being tinted such that the finishing coat provides a primer coating and/or a finish paint coating.

The method may further include applying a second finishing coat of the joint compound composition to substantially the entire drywall surface, wherein the second finishing coat may be tinted such that the second finishing coat provides a primer coating and/or a finish paint coating.

The method may further include the joint compound composition having a composition compatible with conventional jointing compound material and may also exhibit improved properties of thickness, self leveling, elasticity, durability, photographing and/or mold resistance over that of conventional joint compound.

In another embodiment, the invention provides another method of finishing drywall. The method may include applying a joint compound composition along one or more drywall joints and allowing drying; and applying a finishing coat of joint compound composition to substantially all of a drywall surface and allowing drying.

In yet another embodiment, the invention provides a joint compound composition suitable for use in a method of finishing drywall, the method may include the steps of: taping one or more drywall joints with drywall tape and allowing to dry; applying a coat of joint compound composition covering substantially all of the drywall tape and allowing to dry; and applying a finishing coat of joint compound composition to substantially all of a drywall surface and allowing to dry.

The joint compound composition may include a composition compatible with conventional jointing compound material and may also exhibit improved properties of thickness, self leveling, elasticity, durability, and mold resistance over that of conventional joint compound.

### BRIEF DESCRIPTION OF THE DRAWINGS

FIG. 1 shows a flow chart of a prior art method of finishing drywall.

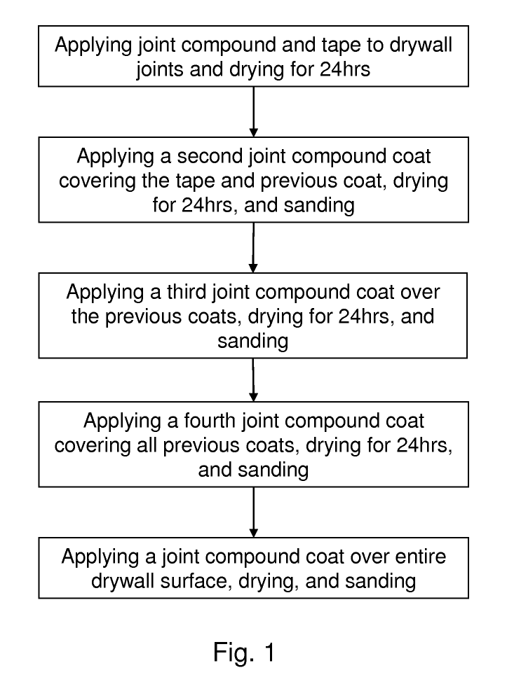

FIG. 2 shows a flow chart of a method of finishing drywall according to an embodiment of the present invention.

### DETAILED DESCRIPTION OF THE INVENTION

The present invention provides methods of improved drywall finishing. The present invention provides a method of finishing drywall by reducing the number of joint compound coats necessary to finish drywall. These methods allow for a higher quality of drywall finishing while increasing the efficiency and reducing the cost of the process. The present invention provides improvements in texture, absorption characteristics, sanding characteristics, processing characteristics and final performance characteristics that is equal to or greater than a Level 5 finish in the current state of the art.

As used herein, the term “drywall” means any wall structure especially for interior application, wherein the wall structure may be prefabricated or not prefabricated material, including gypsum fiberboards, cement fiberboards, cement wallboards, plasterboards, sheetrock and the like. Drywall is typically made of a gypsum or plaster core sandwiched or faced in paper or cardboard and produced like sheets which may be fastened to wall frames, such as with nails, screws, or other suitable means. The drywall has a surface usually placed outwardly in an interior construction such that there is a visible outer surface or face ready to be prepared and decorated.

The method of the present invention provides a drywall finishing process that is more simplified and efficient than that known in the current state of the art. The method of the present invention eliminates a number of the steps conventionally required in the prior art, for example the necessity of multiple coats of joint compound and much of the sanding (up to about 90% less sanding). For example, the method of the present invention may reduce the amount of time required to finish drywall by about half, the method may further reduce about 60% of the labor costs, and may cut overall costs by about 75% to produce a Level 5 finish on walls and ceilings as compared to traditional drywall finishing systems. Additional, embodiments of the present invention eliminate the application of one or more separate coatings of primer, paint, and/or finishing coats to complete the preparation of the wall for decoration. Still further, embodiments of the present invention eliminate the need for application of drywall tape to joints and interior angles.

Because sanding of the drywall is substantially reduced, much of the dust associated with traditional finishing is reduced. This avoids a part of the process that results in much dust in the room as well as in adjacent parts of the building, keeps HVAC systems in buildings cleaner and reduces the amount of cleanup needed. Thus, the present invention provides a greener more eco-friendly drywall finishing process.

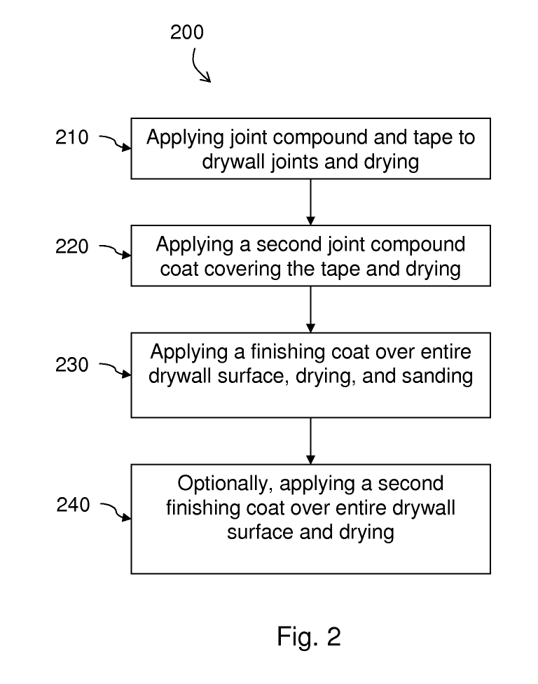

In an embodiment shown in FIG. 2, method 200 of the present invention can include the steps of:

Step 210, taping drywall joints.

In step 210, a drywall joint compound is deposited (preferably as a thin bead), along the drywall joints, and optionally the interior angles. Joint compound is also applied to fastener heads and the like. The drywall joint compound may be applied with a joint finishing knife to the joint (for example a ten inch joint finishing knife) or other suitable means, including but not limited to a spray apparatus. Immediately after application of the joint compound along the drywall joints, and optionally the interior angles, a drywall tape is placed over the bead of the drywall joint compound and the joint finishing knife is run over the tape to press the tape and cause it to adhere to the joint compound. This first coat of the joint compound with the drywall tape is allowed to dry for a sufficient amount of time, for example about 24 hours. Optionally, this first coat of joint compound and drywall tape may be sanded (if needed), to remove excess joint compound, ridges and tool marks, and/or other imperfections. Prior to step 210, the drywall may be hung on wood or metal studs using nails, screws, or other suitable fastener means to form an interior wall of a structure, as is well known in the art.

In an alternative embodiment, the drywall joints are not taped, thus step 210 is eliminated and the method begins with step 220 below.

Step 220, applying a second joint compound coat.

In step 220, once the first coat of joint compound with the drywall tape has dried, then a second coat of joint compound is applied over the first coating and drywall tape to substantially cover the drywall tape and the interface between the drywall tape and the wall. The drywall joint compound may be applied with a finishing knife or other suitable means, including but not limited to a spray apparatus. This second coat of joint compound over the drywall tape is allowed to dry for a sufficient amount of time, for example about 24 hours. Optionally, this second joint compound coat may be sanded (if needed), after drying to remove excess joint compound, ridges and tool marks, and/or other imperfections. In an embodiment wherein step 210 of taping of the drywall joints is not performed the second coat of joint compound becomes the first coat, and is applied directly to the drywall joints, and optionally to the interior angles and/or fastener heads and the like, and allowed to dry for a sufficient amount of time, for example about 24 hours, and optionally, sanded (if needed).

Step 230, applying a finishing joint compound coat.

In step 230, after the second coat of joint compound covering the tape has dried, then a finishing coat of joint compound is applied to the entire surface of the assembled drywall surface. The finishing coat is preferably applied by spray application as a thin coating to the entire assembled drywall surface to achieve a substantially uniform coating of joint compound over the entire drywall surface. Alternatively, the finishing coat may be applied by hand (e.g., by roller application). Optionally, prior to step 230, areas of the interior structure not requiring a finishing coat are covered to prevent them from being exposed to the finishing coat during the spray application. After the finishing coat has dried, light sanding may be performed (if needed), to produce a substantially flat and imperfection free surface. In step 230, the joint compound may be tinted to provide suitable color properties such that the finishing joint compound coat further functions as a primer coating. Thus, eliminating the need for a separate primer paint coating prior to applying finish paint.

Optional step 240, applying a second finishing joint compound coat.

In optional step 240, after the first finishing coat of joint compound has dried and is sanded (if needed), then a second finishing coat of joint compound is applied to the entire surface of the assembled drywall surface. The second finishing coat is preferably applied by spray application as a thin coating to the entire assembled drywall surface. Alternatively, the second finishing coat may be applied by hand (e.g., roller application). After the second finishing coat has dried, light sanding may be performed (if needed), to produce a substantially flat and imperfection free surface. In optional step 240, the joint compound may be tinted to provide suitable color properties such that the second finishing joint compound coat further functions as a primer coating, thus, eliminating the need for a separate primer paint coating prior to applying finish paint. Alternatively, in optional step 240, the joint compound may be tinted to provide suitable color properties such that the second finishing joint compound coat functions as the finish paint. Thus, eliminating the need for a separate primer and/or finish paint coating.

In one embodiment, an airless spray machine is used to apply the finishing coats of joint compound to the drywall surface. In an alternative embodiment the joint compound composition is applied to the drywall surface by spray application, roll coating, vacuum coating, curtain coating, or other suitable means.

The joint compound composition as used and described herein preferably has a composition compatible with conventional jointing compound material (e.g., is a mud based joint compound), and the finishing coat(s) is preferably applied as a skim coat or film coat of relatively low thickness (e.g., in the range of about 80-120 mm), by spray application on the visible surface of the drywall. The finish coating preferably provides a substantially monolithic and homogeneous appearance to the drywall after only one coat after the joints are prepared. The coating also provides a smoothing of the texture of the drywall such that any fibers typically seen under primer or paint after installation of the drywall are substantially covered. Moreover, the coating changes the characteristics of the drywall to provide a surface with an absorbance closer to the absorbance of the jointing material surface when dry, such that the entire finished drywall surface has substantially the same absorbency characteristic. The coating also provides a durable surface such that the sanding on the jointing material does not easily remove or damage the coating surface.

The joint compound may be selected from a group of conventional joint compounds, such as those manufactured by USG Corporation of Chicago, Ill.; National Gypsum Company of Shamrock, N.C.; and others.

In an embodiment, the joint compound composition as used and described herein may be selected from a group of conventional Level 5 finishing compound products, such as but not limited to, LEVELCOAT™ by Magnum Products, Lenexa, Kans.; SHEETROCK® Brand TUFF-HIDE™ by USG Corporation, Chicago, Ill.; or SPRAY-PLAST® by Tool World, Inc. Eustis, Fla. The joint compound is preferably modified to include the properties of improved thickness, self leveling, elasticity, durability, photographing, and/or mold resistance.

The manufacturer may use limestone, dolomite or gypsum as the main ingredient, and may also include other ingredients, such as, plaster of Paris, perlite, vinyl acetate polymer, mica (silicates of chemical compositions), hydrated aluminum silicates (attapulgite clay), starch, crystallized silicone dioxide (quartz), water and latex. Additional ingredients may be added, such as, but not limited to, water, thickeners, primers, and/or other suitable additives to improve the thickness, self leveling, elasticity, durability, photographing, and/or mold resistance properties of the joint compound composition.

The method of the present invention significantly reduces the number of steps and coatings required to finish drywall, thus substantially reducing the cost and finishing time for drywalls. In the present invention, after treating the joints with drywall tape and a single coat of the joint compound, only a single finishing coat applied to the entire drywall surface is required to achieve the equivalent of Level 5 finish or greater. Additional coats to the joints (and the associated sanding with the additional coats) are not necessary.

The methods of the present invention reduce the number of joint compound coats necessary to finish a drywall to achieve a Level 5 or greater finish. In addition to improved efficiencies and reduced costs, the methods of the present invention also result in improved quality of the finished drywall. The even spraying of the joint compound composition of the present invention produces a more monolithic surface, resulting in substantially fewer imperfections than seen with the current state of the art methods, while requiring fewer coats and substantially less sanding. The methods of the present invention produce a flatter, truer surface which resembles a more plaster finish. In addition, the visibility of joints is substantially reduced.

While the present invention has been illustrated by a description of various embodiments and while these embodiments have been described in considerable detail, it is not the intention of the applicants to restrict, or any way limit the scope of the appended claims to such detail. The present invention in its broader aspects is therefore not limited to the specific details, representative apparatus and method, an illustrative example shown and described. The term “the invention” or the like is used with reference to certain specific examples of the many alternative aspects or embodiments of the applicants' invention set forth in this specification, and neither its use nor its absence is intended to limit the scope of the applicants' invention or the scope of the claims. Accordingly, departures may be made from such details without departing from the spirit or scope of applicants' general inventive concept.

What is claimed is:

1. A method of finishing drywall, comprising the steps of:
a. taping one or more drywall joints with drywall tape and allowing to dry;
b. applying a coat of joint compound composition covering substantially all of the drywall tape and allowing to dry; and
c. applying a finishing coat of joint compound composition to substantially all of a drywall surface and allowing to dry.

2. The method of claim 1 wherein taping comprises: applying the joint compound composition along the one or more drywall joints; applying drywall tape over the joint compound composition; applying pressure to the tape to cause it to adhere to the joint compound composition; and allowing the joint compound composition with the drywall tape to dry.

3. The method of claim 1 further comprising applying joint compound composition over fastener heads prior to applying the finishing coat.

4. The method of claim 1 further comprising taping and/or applying the joint compound composition to interior angles prior to applying the finishing coat.

5. The method of claim 1 wherein the finishing coat is applied to the drywall surface by spray application.

6. The method of claim 1 wherein the finishing coat is applied to the drywall surface by roller application.

7. The method of claim 1 wherein the coat of joint compound composition covering substantially all of the drywall tape is applied by spray application.

8. The method of claim 3 further wherein the joint compound composition is applied over the fastener heads by spray application.

9. The method of claim 4 further wherein the joint compound composition is applied to the interior angles by spray application.

10. The method of claim 1 further comprising sanding all or a portion of the coated drywall surface after each coating of the joint compound composition has dried.

11. The method of claim 1 wherein the finishing coat is tinted such that the finishing coat provides a primer coating.

12. The method of claim 1 wherein the finishing coat is tinted such that the finishing coat provides a finish paint coating.

13. The method of claim 1 further comprising applying a second finishing coat of the joint compound composition to substantially the entire drywall surface.

14. The method of claim 13 wherein the second finishing coat is tinted such that the finishing coat provides a primer coating.

15. The method of claim 13 wherein the second finishing coat is tinted such that the finishing coat provides a finish paint coating.

16. The method of claim 1 wherein the joint compound composition comprises a composition compatible with conventional jointing compound material.

17. The method of claim 1 wherein the joint compound composition comprises a composition that exhibits improved properties of thickness, self leveling, elasticity, durability, photographing, and/or mold resistance over that of conventional joint compound.

18. A method of finishing drywall, comprising the steps of:
a. applying a joint compound composition along one or more drywall joints and allowing to dry; and
b. applying a finishing coat of joint compound composition to substantially all of a drywall surface and allowing to dry.

19. The method of claim 18 further comprising applying the joint compound composition over fastener heads prior to applying the finishing coat.

20. The method of claim 18 further comprising applying the joint compound composition to interior angles prior to applying the finishing coat.

21. The method of claim 18 wherein the finishing coat is applied to the drywall surface by spray application.

22. The method of claim 18 wherein the finishing coat is applied to the drywall surface by roller application.

23. The method of claim 18 wherein the joint compound composition applied along the one or more drywall joints is applied by spray application.

24. The method of claim 19 further wherein the joint compound composition is applied over the fastener heads by spray application.

25. The method of claim 20 further wherein the joint compound composition is applied to the interior angles by spray application.

26. The method of claim 18 further comprising sanding all or a portion of the coated drywall surface after each coating of the joint compound composition has dried.

27. The method of claim 18 wherein the finishing coat is tinted such that the finishing coat provides a primer coating.

28. The method of claim 18 wherein the finishing coat is tinted such that the finishing coat provides a finish paint coating.

29. The method of claim 18 further comprising applying a second finishing coat of the joint compound composition to substantially the entire drywall surface.

30. The method of claim 29 wherein the second finishing coat is tinted such that the finishing coat provides a primer coating.

31. The method of claim 29 wherein the second finishing coat is tinted such that the finishing coat provides a finish paint coating.

32. The method of claim 18 wherein the joint compound composition comprises a composition compatible with conventional jointing compound material.

33. The method of claim 18 wherein the joint compound composition comprises a composition that exhibits improved properties of thickness, self leveling, elasticity, durability, photographing, and/or mold resistance over that of conventional joint compound compositions.

34. A joint compound composition suitable for use in a method of finishing drywall, the method comprising the steps of:
a. taping one or more drywall joints with drywall tape and allowing to dry;
b. applying a coat of joint compound composition covering substantially all of the drywall tape and allowing to dry; and
c. applying a finishing coat of joint compound composition to substantially all of a drywall surface and allowing to dry.

35. The joint compound composition of claim 34 comprising a composition compatible with conventional jointing compound material.

36. The joint compound composition of claim 34 comprising a composition that exhibits improved properties of thickness, self leveling, elasticity, durability, photographing, and/or mold resistance over that of conventional joint compound compositions.
